(19) United States
(12) Patent Application Publication
(10) Pub. No.: US 2017/0061917 A1
(43) Pub. Date: Mar. 2, 2017

(54) Array Substrate, Display Panel and Driving Method Thereof

(71) Applicants: BOE TECHNOLOGY GROUP CO., LTD., Beijing (CN); HEFEI XINSHENG OPTOELECTRONICS TECHNOLOGY CO., LTD, Hefei (CN)

(72) Inventors: Mo CHEN, Beijing (CN); Jian ZHAO, Beijing (CN); Jing SUN, Beijing (CN)

(21) Appl. No.: 15/138,471

(22) Filed: Apr. 26, 2016

(30) Foreign Application Priority Data
Aug. 28, 2015 (CN) 201510543768.8

(51) Int. Cl. G09G 3/36

(52) U.S. Cl. CPC G09G 3/3688; G09G 3/3614; G09G 2300/0426; G09G 2310/0251; G09G 2320/0209

(57) ABSTRACT

The invention discloses an array substrate, a display panel and a driving method thereof. The array substrate is divided into a plurality of pixel units, each pixel unit comprises a discharge module therein, and the control terminal of the discharge module is connected with a gate line in a row previous to the row where the pixel unit is located, so that a pixel electrode of the pixel unit in the current row is connected with a low-level. signal terminal when the previous row of gate line is scanned. The invention can avoid afterimages and improve the display quality.

### CROSS-REFERENCE TO RELATED APPLICATION

This application claims priority to Chinese Patent Application No. 201510543768.8, titled “Array Substrate Display Panel and Driving Method Thereof” and filed on Aug. 28, 2015, the contents of which are incorporated by reference in the entirety.

### FIELD OF THE INVENTION

The present invention relates to the field of display technology, and particularly relates to an array substrate, a display panel including the array substrate and a driving method for the display panel.

### BACKGROUND OF THE INVENTION

A liquid crystal display panel includes an array substrate (TFT substrate), a color filter substrate (CF substrate) and a liquid crystal layer therebetween. As shown in FIG. 1, each pixel unit in an existing array substrate includes a thin film transistor serving as a switching control element and a pixel electrode, and the pixel electrode and a common electrode form a liquid crystal capacitor. Different voltages are input to the pixel electrode via the thin film transistors under the control of data lines and scan lines intersecting each other, so that different electric fields are formed in the liquid crystal capacitor to control the deflection of liquid crystals, thus realizing the display function.

Due to characteristics of the liquid crystal display panel itself, the direction of the electric field in the liquid crystal capacitor needs to be changed when each frame is displayed, namely polarity reversal. During the polarity reversal, positive and negative charges on two electrodes of the liquid crystal capacitor cannot completely cancel each other out due to crosstalk of parasitic capacitance and leak current of each thin film transistor, and the residual charges gathered on the electrodes will influence the deflection of liquid crystals. As a result, afterimages are formed.

### SUMMARY OF THE INVENTION

An object of the present invention is to provide an array substrate, a display panel and a driving method thereof, for avoiding afterimages and then improving the display quality.

In order to solve the above technical problems, a first aspect of the present invention provides an array substrate, including a plurality of gate lines and a plurality of data lines, the plurality of gate lines and the plurality of data lines dividing the array substrate into a plurality of pixel units arranged in multiple rows, each pixel unit including a switching transistor therein, wherein each pixel unit further includes a discharge module therein, a control terminal of the discharge module is connected with a gate line in a row previous to a row where the pixel unit is located, and the discharge module is used for connecting a pixel electrode of the pixel unit in the current row to a low-level signal terminal when a previous row of gate line is scanned.

Optionally, the array substrate includes a common electrode line, and the low-level signal terminal is connected with the common electrode line.

Optionally, the discharge module includes a discharge transistor, a gate of the discharge transistor is connected with the previous row of gate line, a first electrode of the discharge transistor is connected with the pixel electrode of the pixel unit, and a second electrode of the discharge transistor is connected with the low-level signal terminal.

Optionally, a gate of the switching transistor is connected with the current row of gate line, a first electrode of the switching transistor is connected with a data line in a column where the pixel unit is located, and a second electrode of the switching transistor is connected with the pixel electrode of the pixel unit.

A second aspect of the present invention provides a display panel, including the above array substrate provided by the present invention.

A third aspect of the present invention provides a driving method for a display panel, the display panel including a plurality of gate lines and a plurality of data lines, the plurality of gate lines and the plurality of data lines dividing the display panel into a plurality of pixel units arranged in multiple rows, wherein the driving method includes a step of:

before the pixel units in a row are driven to display, connecting a pixel electrode of each pixel unit in the row to a low-level signal terminal, to release charges on the pixel electrode.

Optionally, the display panel includes a common electrode line, the low-level signal terminal is connected with the common electrode line, and the step of connecting the pixel electrode of each pixel unit in the row to the low-level signal terminal includes:

connecting the pixel electrode of each pixel unit in the row to the common electrode line.

Optionally, each pixel unit includes a discharge module therein, the discharge module includes a discharge transistor, a gate of the discharge transistor is connected with a gate line in a row previous to a row where the pixel unit is located, a first electrode of the discharge transistor is connected with the pixel electrode in the pixel unit, and a second electrode of the discharge transistor is connected with the low-level signal terminal;

wherein the driving method further includes: when the pixel units in the current row are driven to display, turning on the discharge transistors in the pixel units in a next row, to discharge the pixel electrodes of the pixel units in the next row.

Optionally, each pixel unit includes a switching transistor, a gate of the switching transistor is connected with a gate line in the row where the pixel unit is located, a first electrode of the switching transistor is connected with the data line in the column where the pixel unit is located, and a second electrode of the switching transistor is connected with the pixel electrode of the pixel unit;

wherein the step of turning on the discharge transistors in the pixel units in the next row when the pixel units in the current row are driven to display includes:

providing a high-level signal to the gate line of the current row of pixel units, so that the first electrode and the second electrode of the switching transistor in each pixel unit in the current row are connected, and the first electrode and the second electrode of the discharge transistor in each pixel unit in the next row are connected.

Optionally, when providing a high-level signal to the gate line of the current row of pixel units:

connecting the pixel electrodes of the pixel units in the current row to the data lines so that gray-scale voltages are written into the pixel electrodes of the pixel units in the current row, and meanwhile, connecting the pixel electrodes of the pixel units in the next row to the common electrode line so that charges on the pixel electrodes of the pixel units in the next row are released to the common electrode line.

In the present invention, each pixel unit is provided with a discharge module, which can sufficiently release the residual charges on the pixel electrode before each pixel unit displays, so that accumulation of the residual charges in the polarity reversal process is avoided, then afterimages can be avoided, and the display quality is improved.

### BRIEF DESCRIPTION OF THE DRAWINGS

The accompanying drawings are used for providing a further understanding of the present invention, constituting a part of the specification, and interpreting the present invention together with specific embodiments below, rather than limiting the present invention.

FIG. 1 is a schematic diagram of an existing array substrate; and

FIG. 2 is a schematic diagram of an array substrate provided by an embodiment of the present invention.

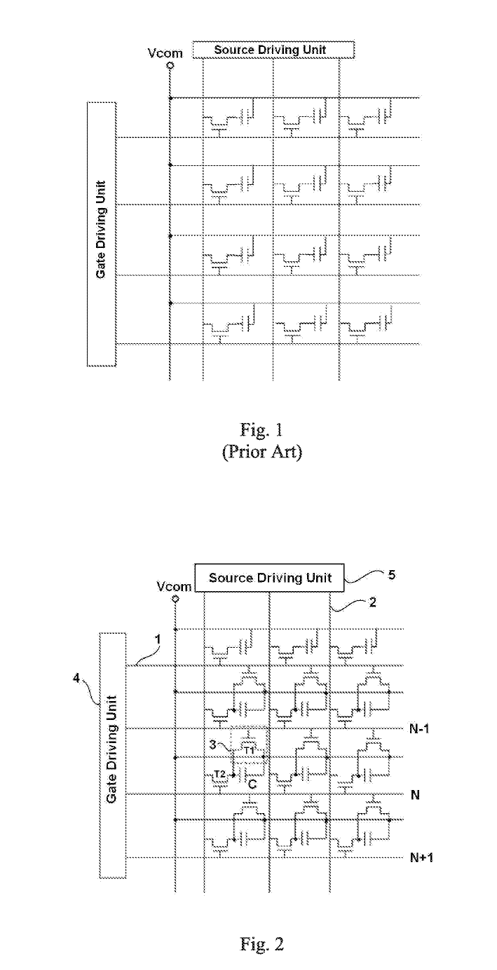

### REFERENCE NUMERALS

1: gate line; 2: data line; 3: discharge module; 4: gate driving unit; 5: source driving unit; Vcom: common electrode line; T1: discharge transistor; T2: switching transistor; C: liquid crystal capacitor.

### DESCRIPTION OF THE PREFERRED EMBODIMENT

The specific embodiments of the present invention will be described in detail below in conjunction with the accompanying drawings. It should be understood that the specific embodiments described herein are merely used for describing and explaining the present invention, rather than limiting the present invention.

An embodiment of the present invention provides an array substrate, as shown in FIG. 2. The array substrate includes a plurality of gate lines 1 and a plurality of data lines 2, the plurality of gate lines 1 and the plurality of data lines 2 divide the array substrate into a plurality of pixel units arranged in multiple rows, in each of which a switching transistor T2 and a discharge module 3 are included. The control terminal of the discharge module 3 is connected with a gate line in a row previous to the row where the pixel unit corresponding to the discharge module 3 is located (i.e., the previous row of gate line or the gate line in the previous row). The discharge module 3 is used for connecting a pixel electrode of the pixel unit in the current row to a low-level signal terminal when the previous row of gate line is scanned.

As shown in FIG. 2, the control terminal of the discharge module 3 in the pixel unit in the N^{th} row is connected with the (N−1)^{th} row of gate line. When the (N−1)^{th} row of gate line is scanned, the pixel electrode of the pixel unit in the N^{th} row is connected to the low-level signal terminal, so that charges in the pixel electrode are sufficiently released to avoid accumulation of residual charges, reduce afterimages and improve the display quality.

Optionally, the array substrate includes a common electrode line Vcom, and the low-level signal terminal is connected with the common electrode line Vcom. That is to say, after the control terminal of the discharge module 3 receives a turn-on signal, the discharge module 3 connects the pixel electrode with the common electrode line Vcom, so that charges on the pixel electrode are quickly released to the common electrode to avoid afterimages.

Specifically, the discharge module 3 includes a discharge transistor T1, a gate of the discharge transistor T1 is connected with the previous row of gate line, a first electrode of the discharge transistor T1 is connected with the pixel electrode of the pixel unit, and a second electrode of the discharge transistor T1 is connected with the low-level signal terminal, namely connected with the common electrode line Vcom. When the previous row of gate line is scanned, the discharge transistor T1 is turned on, so that charges on the pixel electrode in the current row are released to the common electrode.

Generally, the array substrate further includes a gate driving unit 4 and a source driving unit 5. The plurality of gate lines 1 are each connected with the gate driving unit 4, and are used for receiving scan signals sent by the gate driving unit 4. The plurality of data lines 2 are each connected with the source driving unit 5, and are used for receiving gray-scale signals sent by the source driving unit 5.

In each pixel unit, the gate of the switching transistor T2 is connected with the gate line (the current row of gate line) in the row where the pixel unit is located, the first electrode of the switching transistor T2 is connected with the data line in the column where the pixel unit is located, and the second electrode of the switching transistor T2 is connected with the pixel electrode of the pixel unit. When the current row of gate line is scanned, the switching transistor T2 is turned on so that a gray-scale voltage is written into the pixel unit.

The working process of the array substrate of the present invention will be described in detail below in conjunction with the embodiment shown in FIG. 2.

The pixel unit in the N^{th} row is taken as an example. The common electrode and the pixel electrode in each pixel unit constitute a liquid crystal capacitor C, the pixel electrode is connected with the source driving unit 5 through the switching transistor T2, and the on and off states of the switching transistor T2 are controlled by the current row (the N^{th} row) of gate line. Meanwhile, the pixel electrode of the pixel unit is connected with the common electrode line Vcom through the discharge transistor T1, and the on and off states of the discharge transistor T1 are controlled by the previous row (the (N−1)^{th} row) of gate line.

When the gate driving unit 4 applies a high level to the (N−1)^{th} row of gate line, the pixel units in the (N−1)^{th} row display, meanwhile, the discharge transistor T1 in the pixel unit in the N^{th} row is turned on, then the pixel electrode in the N^{th} row is connected to the common electrode line Vcom, so charges on the pixel electrode in the N^{th} row are discharged to the common electrode, and the voltage of the pixel electrode in the N^{th} row is consistent with that of Vcom.

When the gate driving unit 4 stops applying the high level to the (N−1)^{th} row of gate line, the gray-scale voltage of the pixel electrode in the (N−1)^{th} row is kept unchanged for a frame of time, so the discharge transistor T1 in the pixel unit in the N^{th} row is cut off, and as a result, the pixel electrode in the N^{th} row is no longer connected to the common electrode, but a liquid crystal capacitor C is formed therebetween. Subsequently, the gate driving unit 4 applies a high level to the N^{th} row of gate line, and the source driving unit 5 inputs a gray-scale voltage to the pixel electrode of the pixel unit in the N^{th} row, so that the pixel unit in the N^{th} row normally displays. Meanwhile, the discharge transistor T1 in the pixel unit in the (N+1)^{th} row is turned on, and the pixel electrode in the (N+1)^{th} row is thus connected to the common electrode line Vcom, so that charges of the pixel electrode in the (N+1)^{th} row are discharged to the common electrode.

When the gate driving unit 4 stops applying the high level to the N^{th} row of gate line, the gray-scale voltage of the pixel electrode in the N^{th} row is kept unchanged for a frame of time. Meanwhile, the (N+1)^{th} row of gate line outputs a high level, so that the pixel unit in the (N+1)^{th} row normally displays. The rest can be done in the same manner, which is not redundantly described herein.

An embodiment of the present invention further provides a display panel, including the above array substrate provided by the present invention. In the display panel of the present invention, the array substrate is provided with discharge modules, which can sufficiently release the residual charges on the pixel electrode before each pixel unit displays, so that accumulation of the residual charges in the polarity reversal process of liquid crystals in the display panel is avoided, then afterimages can be avoided, and the display quality is improved.

An embodiment of the present invention further provides a driving method for a display panel, the display panel including a plurality of gate lines and a plurality of data lines, the plurality of gate lines and the plurality of data lines dividing the display panel into a plurality of pixel units arranged in multiple rows, wherein the driving method includes the following step:

before pixel units in a row are driven to display, connecting a pixel electrode of each pixel unit in the row to a low-level signal terminal, to release charges in the pixel electrode.

According to the embodiment of the present invention, before the pixel unit in each row displays, the residual charges in the pixel electrode of the pixel unit are sufficiently released, so that accumulation of the residual charges in the polarity reversal process is avoided, then afterimages can be avoided, and the display quality is improved.

Optionally, the display panel includes a common electrode line, the low-level signal terminal is connected with the common electrode line, and the step of connecting a pixel electrode of each pixel unit in the row to a low-level signal terminal includes:

connecting the pixel electrode of each pixel unit in the row to the common electrode line, so that charges on the pixel electrode are quickly released to the common electrode.

Further, each pixel unit includes a discharge module therein, the discharge module includes a discharge transistor, the gate of the discharge transistor is connected with a gate line in a row previous to the row where the pixel unit is located, the first electrode of the discharge transistor is connected with the pixel electrode in the pixel unit, and the second electrode of the discharge transistor is connected with the low-level signal terminal;

wherein the driving method further includes: when the pixel units in a current row are driven to display, turning on the discharge transistors in the pixel units in a next row, to discharge the pixel electrodes of the pixel units in the next row.

Further, each pixel unit includes a switching transistor therein, the gate of the switching transistor is connected with a gate line in the row where the pixel unit is located, the first electrode of the switching transistor is connected with the data line in the column where the pixel unit is located, and the second electrode of the switching transistor is connected with the pixel electrode of the pixel unit;

wherein, the step of turning on the discharge transistors in the pixel units in the next row when the pixel units in the current row are driven to display includes:

providing a high-level signal to the gate line of the current row of pixel units, so that the first electrode and the second electrode of the switching transistor in each pixel unit in the current row are connected, and the first electrode and the second electrode of the discharge transistor in each pixel unit in the next row are connected,

When providing a high-level signal to the gate line of the current row of pixel units:

connecting the pixel electrodes of the pixel units in the current row to the data lines so that gray-scale voltages are written into the pixel electrodes of the pixel units in the current row, meanwhile, connecting the pixel electrodes of the pixel units in the next row to the common electrode line so that charges in the pixel electrodes of the pixel units in the next row are released to the common electrode line.

By adopting the driving method of the present invention, afterimages in the display panel can be effectively avoided, so that the display quality is improved.

It could be understood that the above embodiments are merely exemplary embodiments adopted for describing the principle of the present invention, but the present invention is not limited thereto. Various variations and improvements may be made by those of ordinary skill in the art without departing from the spirit and essence of the present invention, and these variations and improvements shall also be encompassed within the protection scope of the present invention.

1. An array substrate, comprising a plurality of gate lines and a plurality of data lines, the plurality of gate lines and the plurality of data lines dividing the array substrate into a plurality of pixel units arranged in multiple rows, each pixel unit comprising a switching transistor therein,
wherein each pixel unit further comprises a discharge module therein, a control. terminal of the discharge module is connected with a gate line in a row previous to a row where the pixel unit is located, and the discharge module is used for connecting a pixel electrode of the pixel unit in the current row to a low-level signal terminal when the previous row of gate line is scanned.

2. The array substrate of claim 1, further comprising a common electrode line, wherein the low-level signal terminal is connected with the common electrode line.

3. The array substrate of claim 1, wherein the discharge module comprises a discharge transistor, a gate of the discharge transistor is connected with the previous row of gate line, a first electrode of the discharge transistor is connected with the pixel electrode of the pixel unit, and a second electrode of the discharge transistor is connected with the low-level signal terminal.

4. The array substrate of claim 1, wherein a gate of the switching transistor is connected with the current row of gate line, a first electrode of the switching transistor is connected with a data line in a column where the pixel unit is located, and a second electrode of the switching transistor is connected with the pixel electrode of the pixel unit.

5. The array substrate of claim 2, wherein a gate of the switching transistor is connected with the current row of gate line, a first electrode of the switching transistor is connected with a data line in a column where the pixel unit is located, and a second electrode of the switching transistor is connected with the pixel electrode of the pixel unit.

6. The array substrate of claim 3, wherein a gate of the switching transistor is connected with the current row of gate line, a first electrode of the switching transistor is connected with a data line in a column where the pixel unit is located, and a second electrode of the switching transistor is connected with the pixel electrode of the pixel unit.

7. A display panel, comprising the array substrate of claim 1.

8. The display panel of claim 7, wherein the array substrate comprises a common electrode line, and the low-level signal terminal is connected with the common electrode line.

9. The display panel of claim 7, wherein the discharge module comprises a discharge transistor, a gate of the discharge transistor is connected with the previous row of gate line, a first electrode of the discharge transistor is connected with the pixel electrode of the pixel unit, and a second electrode of the discharge transistor is connected with the low-level signal terminal.

10. The display panel of claim 7, wherein a gate of the switching transistor is connected with the current row of gate line, a first electrode of the switching transistor is connected with a data line in a column where the pixel unit is located, and a second electrode of the switching transistor is connected with the pixel electrode of the pixel unit.

11. The display panel of claim 8, wherein a gate of the switching transistor is connected with the current row of gate line, a first electrode of the switching transistor is connected with a data line in a column where the pixel unit is located, and a second electrode of the switching transistor is connected with the pixel electrode of the pixel unit.

12. The display panel of claim 9, wherein a gate of the switching transistor is connected with the current row of gate line, a first electrode of the switching transistor is connected with a data line in a column where the pixel unit is located, and a second electrode of the switching transistor is connected with the pixel electrode of the pixel unit.

13. A driving method for a display panel, the display panel comprising a plurality of gate lines and a plurality of data lines, the plurality of gate lines and the plurality of data lines dividing the display panel into a plurality of pixel units arranged in multiple rows, wherein the driving method comprises a step of:
before pixel units in a row are driven to display, connecting a pixel electrode of each pixel unit in the row to a low-level signal terminal, to release charges on the pixel electrode.

14. The driving method of claim 13, wherein the display panel comprises a common electrode line, the low-level signal terminal is connected with the common electrode line, and the step of connecting the pixel electrode of each pixel unit in the row to the low-level signal terminal comprises:
connecting the pixel electrode of each pixel unit in the row to the common electrode line.

15. The driving method of claim 14, wherein each pixel unit comprises a discharge module therein, the discharge module comprises a discharge transistor, a gate of the discharge transistor is connected with a gate line in a row previous to a row where the pixel unit is located, a first electrode of the discharge transistor is connected with the pixel electrode in the pixel unit, and a second electrode of the discharge transistor is connected with the low-level signal terminal;
wherein the driving method further comprises: when the pixel units in the current row are driven to display, turning on the discharge transistors in pixel units in a next row, to discharge the pixel electrodes of the pixel units in the next row.

16. The driving method of claim 15, wherein each pixel unit comprises a switching transistor therein, a gate of the switching transistor is connected with a gate line in the row where the pixel unit is located, a first electrode of the switching transistor is connected with the data line in the column where the pixel unit is located, and a second electrode of the switching transistor is connected with the pixel electrode of the pixel unit;
wherein the step of turning on the discharge transistors in the pixel units in the next row when the pixel units in the current row are driven to display comprises:
providing a high-level signal to the gate line of the current row of pixel units, so that the first electrode and the second electrode of the switching transistor in each pixel unit in the current row are connected, and the first electrode and the second electrode of the discharge transistor in each pixel unit in the next row are connected.

17. The driving method of claim 16, wherein when providing a high-level signal to the gate line of the current row of pixel units:
connecting the pixel electrodes of the pixel units in the current row to the data lines so that gray-scale voltages are written into the pixel electrodes of the pixel units in the current row, and meanwhile, connecting the pixel electrodes of the pixel units in the next row to the common electrode line so that charges on the pixel electrodes of the pixel units in the next row are released to the common electrode line.
